(19) United States
(12) Patent Application Publication
(10) Pub. No.: US 2025/0390268 A1
(43) Pub. Date: Dec. 25, 2025

(54) IMAGE AREA GENERATION SYSTEM AND PROGRAM AND IMAGE AREA DISPLAY SPACE

(71) Applicant: Eizo System Co.,Ltd., Tokyo (JP)

(72) Inventors: Ryuji TAKANO, Tokyo (JP); Kazuhiko SAKAMOTO, Tokyo (JP); Osamu TOMOSUE, Tokyo (JP)

(21) Appl. No.: 18/877,577

(22) PCT Filed: Jun. 20, 2023
(86) PCT No.: PCT/JP2023/022776

§ 371 Date: Dec. 20, 2024

(30) Foreign Application Priority Data
Jun. 24, 2022 (JP) 2022-102239

(51) Int. Cl. G06F 3/14; G06F 3/16; H04N 9/31; H04N 23/698

(52) U.S. Cl. CPC G06F 3/1446; G06F 3/165; H04N 9/3147; H04N 9/3185; H04N 23/698

(57) ABSTRACT

A dynamic image taken by an omnidirectional imaging device is transmitted toward the inside of a virtual space at high speed and displayed with a realistic sensation. Respective static images constituting an acquired dynamic image are clipped into a plurality of image areas corresponding to a positional relation between the respective surfaces, the respective clipped image areas are assigned to the respective surfaces, and when data including the respective assigned image areas is transmitted to respective display devices for displaying the image areas on the respective surfaces through mutually different channels, an adjustment to mutually synchronize the respective image areas of the transmitted data on a time-series basis is performed.

### TECHNICAL FIELD

The present invention relates to an image area generation system and program for generating image areas displayed on respective rectangular surfaces surrounding a space, and an image area display space.

### BACKGROUND ART

Recently, a service in which an operation character (avatar) operated by a user themselves can freely act in a three-dimensional virtual space created online has become popular. In this service, amusements, such as games and sightseeing, and economic activities, such as buying and selling goods and services, can also be performed, and various activities can be performed using a virtual space as one living space. Especially, with the improvement of techniques of virtual reality (VR) and augmented reality (AR), users can experience more realistic virtual spaces, and the demand for the service is expected to rapidly increase in the future.

When using a service that uses a virtual space, a user wears a glasses type or goggles type head-mounted video display device on their head. Such a head-mounted video display device includes a motion sensor, a microphone, and the like, and can freely change videos to be displayed corresponding to the motion and the voice of the user. This allows the user to freely move an avatar in the virtual space via the head-mounted video display device and freely move their gaze, thereby enjoying various services.

However, in the above-described conventional service using a virtual space, the user needs to wear the head-mounted video display device every time, and it is necessary to respond to a request to reduce an oppressive feeling and inconvenience due to the wearing and an effort to put on the device. There is also a problem of an influence on the body such as what is called VR sickness due to a gap between information visually obtained via the head-mounted video display device and information that the real body receives. Additionally, there is an increasing desire that a large number of people simultaneously share and watch an omnidirectional video in one virtual space, instead of independently watching a video while respective users individually wear the head-mounted video display device.

Conventionally, for example, as described in Patent Document 1, a method for displaying an omnidirectional video in a virtual space without wearing a head-mounted video display device has been proposed. However, a specific method for actually transmitting various kinds of dynamic image content and dynamic images taken by an omnidirectional imaging device toward the inside of the virtual space at high speed and a method for a display with a realistic sensation are not mentioned. While respective surfaces constituting an available virtual space are configured with various vertical/horizontal size ratios, a technique itself for generating image areas with a realistic sensation corresponding to the shape of the virtual space including the surfaces having such various size ratios according to circumstances has not been currently proposed.
Patent Document 1: JP-A-2021-177587

### DISCLOSURE OF THE INVENTION

### Problems to be Solved by the Invention

Therefore, the present invention has been made in consideration of the above-described problems, and it is an object of the present invention to provide an image area generation system and program and an image area display space that, when image areas to be displayed on respective rectangular surfaces surrounding a space are generated, allow a user to experience a realistic sensation in a virtual space as if the user themselves were actually present at a place without causing the user to wear a head-mounted video display device every time, moreover, allow multiple people to simultaneously share and watch an omnidirectional video in one virtual space, and further, allow transmitting a dynamic image taken by an omnidirectional imaging device toward the inside of the virtual space at high speed and displaying the dynamic image with a realistic sensation. The present invention also provides the image area generation system and program and the image area display space capable of generating an image area with a realistic sensation corresponding to the shape of a virtual space including surfaces having various size ratios according to circumstances.

### Solutions to the Problems

To solve the above-described problems, the inventors have invented an image area generation system and program that clip respective static images constituting an acquired dynamic image into a plurality of image areas corresponding to the positional relation between the respective surfaces, assign the respective clipped image areas to the respective surfaces, and when transmitting data including the respective assigned image areas to respective display devices for displaying the image areas on the respective surfaces through mutually different channels, perform an adjustment to mutually synchronize the respective image areas of the transmitted data on a time-series basis.

An image area generation system according to a first invention is an image area generation system that generates image areas displayed on respective rectangular surfaces surrounding a space. The image area generation system includes dynamic image acquiring means that acquires a dynamic image, image area clipping means that clips respective static images constituting the dynamic image acquired by the dynamic image acquiring means into a plurality of image areas corresponding to a positional relation between the respective surfaces, assigning means that assigns the respective image areas clipped by the image area clipping means to the respective surfaces, and data transmitting means that transmits data including the respective image areas assigned by the assigning means to respective display devices for displaying the image areas on the respective surfaces through mutually different channels. The data transmitting means performs an adjustment to mutually synchronize the respective image areas of the transmitted data on a time-series basis.

The image area generation system according to a second invention, which is in the first invention, further includes the display devices that display the image areas included in the data transmitted by the transmitting means on the respective surfaces.

In the image area generation system according to a third invention, which is in the first invention or the second invention, the dynamic image acquiring means acquires the dynamic image taken by an omnidirectional imaging device.

In the image area generation system according to a fourth invention, which is in the first invention, the image area clipping means clips the image areas to be assigned to the respective surfaces based on a vertical/horizontal size ratio between the respective surfaces.

In the image area generation system according to a fifth invention, which is in the fourth invention, the image area clipping means performs an adjustment such that each of the clipped image areas has a rectangular shape.

An image area generation system according to a sixth invention further includes determining means that determines a vertical/horizontal size ratio between the respective surfaces based on images of the respective surfaces taken by an imaging device installed in the space. The image area clipping means clips the image areas to be assigned to the respective surfaces based on the vertical/horizontal size ratio between the respective surfaces determined by the determining means.

In the image area generation system according to a seventh invention, which is in the first invention, the image area clipping means sequentially adds time-series identification information to each of the image areas clipped from the static images, and the assigning means performs an adjustment for synchronization based on the time-series identification information added to each of the image areas.

In the image area generation system according to an eighth invention, which is in the second invention, the display devices are configured by projection display devices that project and display the respective image areas on the respective surfaces, and the image area clipping means clips the image areas to be assigned to the respective surfaces further based on a positional relation between the projection display devices or projection directions and view angles of the respective projection display devices with respect to the respective surfaces.

An image area generation system according to a ninth invention is an image area display space that displays image areas on respective rectangular surfaces surrounding a space. The image area display space includes the respective rectangular surfaces surrounding the space, dynamic image acquiring means that acquires a dynamic image, image area clipping means that clips respective static images constituting the dynamic image acquired by the dynamic image acquiring means into a plurality of image areas corresponding to a positional relation between the respective surfaces, assigning means that assigns the respective image areas clipped by the image area clipping means to the respective surfaces, and data transmitting means that transmits data including the respective image areas assigned by the assigning means to respective display devices for displaying the image areas on the respective surfaces through mutually different channels. The data transmitting means performs an adjustment to mutually synchronize the respective image areas of the transmitted data on a time-series basis.

The image area display space according to a tenth invention, which is in the ninth invention, further includes determining means that determines a vertical/horizontal size ratio between the respective surfaces based on images of the respective surfaces taken by an imaging device installed in the space. The image area clipping means clips the image areas to be assigned to the respective surfaces based on the vertical/horizontal size ratio between the respective surfaces determined by the determining means.

An image area generation program according to an eleventh invention is an image area generation program for generating image areas displayed on respective rectangular surfaces surrounding a space. The image area generation program includes a dynamic image acquiring step of acquiring a dynamic image, an image area clipping step of clipping respective static images constituting the dynamic image acquired in the dynamic image acquiring step into a plurality of image areas corresponding to a positional relation between the respective surfaces, an assigning step of assigning the respective image areas clipped in the image area clipping step to the respective surfaces, and a data transmitting step of transmitting data including the respective image areas assigned in the assigning step to respective display devices for displaying the image areas on the respective surfaces through mutually different channels. The data transmitting step performs an adjustment to mutually synchronize the respective image areas of the transmitted data on a time-series basis.

An image area generation system according to a twelfth invention is an image area generation system that generates image areas reproduced on respective rectangular surfaces surrounding a space. The image area generation system includes dynamic image acquiring means that acquires a dynamic image of at least any of a live video and an archived video, audio information corresponding to the dynamic image, and delivery destination information for delivering the dynamic image and the audio information, image area clipping means that clips respective static images constituting the dynamic image into a plurality of image areas corresponding to a positional relation between the respective surfaces based on the delivery destination information acquired by the dynamic image acquiring means, assigning means that determines features of the respective image areas clipped by the image area clipping means and a feature of the space and assigns the respective image areas to the respective surfaces based on the determined features of the respective image areas and feature of the space, as well as assigns the audio information based on the respective assigned image areas, and data transmitting means that transmits data including at least any of the respective image areas or the audio information assigned by the assigning means to respective reproduction devices including at least any of respective display devices for reproducing the image areas on the respective surfaces or respective audio devices for reproducing the audio information through mutually different channels.

In the image area generation system according to a thirteenth invention, which is in the twelfth invention, the image area clipping means clips the respective static images constituting the dynamic image into the plurality of image areas corresponding to the positional relation between the respective surfaces based on the audio information.

In the image area generation system according to a fourteenth invention, which is in the twelfth invention, the data transmitting means performs an adjustment to mutually synchronize the respective image areas and the audio information of the transmitted data on a time-series basis.

An image area generation system according to a fifteenth invention is an image area generation system that generates image areas reproduced on respective rectangular surfaces surrounding a space. The image area generation system includes dynamic image acquiring means that acquires a dynamic image of at least any of a live video and an archived video, audio information corresponding to the dynamic image, and delivery destination information for delivering the dynamic image and the audio information, image area clipping means that clips respective static images constituting the dynamic image into a plurality of image areas corresponding to a positional relation between the respective surfaces based on the delivery destination information acquired by the dynamic image acquiring means, extracting means that extracts features of the respective image areas clipped by the image area clipping means and spectator information including any one or more of a position, a gaze, and a direction of a head of a spectator, and a voice emitted from the spectator in the space, assigning means that assigns the respective image areas to the respective surfaces and assigns the audio information based on the respective assigned image areas, and data transmitting means that transmits data including at least any of the respective image areas or the audio information assigned by the assigning means to respective reproduction devices including at least any of respective display devices for reproducing the image areas on the respective surfaces or respective audio devices for reproducing the audio information through mutually different channels. The dynamic image acquiring means resets a shooting condition of the live video based on the features of the respective image areas and the spectator information extracted by the extracting means.

An image area space according to a sixteenth invention is an image area display space that reproduces image areas on respective rectangular surfaces surrounding a space. The image area display space includes the respective rectangular surfaces surrounding the space, dynamic image acquiring means that acquires a dynamic image of at least any of a live video and an archived video, audio information corresponding to the dynamic image, and delivery destination information for delivering the dynamic image and the audio information, image area clipping means that clips respective static images constituting the dynamic image into a plurality of image areas corresponding to a positional relation between the respective surfaces based on the delivery destination information acquired by the dynamic image acquiring means, assigning means that determines features of the respective image areas clipped by the image area clipping means and a feature of the space and assigns the respective image areas to the respective surfaces based on the determined features of the respective image areas and feature of the space, as well as assigns the audio information based on the respective assigned image areas, and data transmitting means that transmits data including at least any of the respective image areas or the audio information assigned by the assigning means to respective reproduction devices including at least any of respective display devices for reproducing the image areas on the respective surfaces or respective audio devices for reproducing the audio information through mutually different channels.

An image area generation program according to a seventeenth invention is an image area generation program for generating image areas reproduced on respective rectangular surfaces surrounding a space. The image area generation program includes a dynamic image acquiring step of acquiring a dynamic image of at least any of a live video and an archived video, audio information corresponding to the dynamic image, and delivery destination information for delivering the dynamic image and the audio information, an image area clipping step of clipping respective static images constituting the dynamic image into a plurality of image areas corresponding to a positional relation between the respective surfaces based on the delivery destination information acquired in the dynamic image acquiring step, an assigning step of determining features of the respective image areas clipped in the image area clipping step and a feature of the space and assigning the respective image areas to the respective surfaces based on the determined features of the respective image areas and feature of the space, as well as assigning the audio information based on the respective assigned image areas, and a data transmitting step of transmitting data including at least any of the respective image areas or the audio information assigned in the assigning step to respective reproduction devices including at least any of respective display devices for reproducing the image areas on the respective surfaces or respective audio devices for reproducing the audio information through mutually different channels.

### Effects of the Invention

According to the present invention configured as described above, when the spectator enters the space, the spectator can view the image areas displayed on the respective surfaces. Since the image areas are originally clipped from an omnidirectional moving image into six surfaces, by visually perceiving the image areas displayed on the respective surfaces, the spectator in the space can enjoy a feeling as if the spectator were standing at the center of the omnidirectional moving image. By visually perceiving the respective surfaces, the spectator sees the image area displayed on the visually perceived surface. That is, since the image area corresponding to a visually perceived direction is seen, a feeling similar to that of VR can be obtained. Moreover, without wearing a glasses type or goggles type head-mounted video display device necessary for experiencing VR, a realistic sensation as if the spectator themselves were actually present at a place can be experienced in the space. Therefore, an oppressive feeling and inconvenience due to the wearing of the head-mounted video display device and an effort to put on the device can be eliminated. Further, an influence on the body such as what is called VR sickness due to a gap between information visually obtained via the head-mounted video display device and information that the real body receives is also eliminated.

Furthermore, according to the present invention, a plurality of spectators can simultaneously enter the space and visually perceive the common image area, thus allowing achievement of simultaneously sharing an omnidirectional video by a large number of people in one virtual space, which cannot be achieved with conventional VR.

According to the present invention, the respective image areas can be independently transmitted to the display devices through mutually different communication paths, thereby allowing providing content to the space at high speed and low cost. Moreover, a mismatch on a time-series basis between the respective image areas possibly generated by independently transmitting the respective image areas through the mutually different communication paths can be eliminated by a synchronization adjustment process.

Furthermore, according to the present invention, the dynamic image of at least any of the live video and the archived video, the audio information corresponding to the dynamic image, and the delivery destination information for delivering the dynamic image and the audio information are acquired. Therefore, the features of the respective image areas clipped into the plurality of image areas and the feature of the space can be determined based on the delivery destination information, and the respective surfaces and the audio information can be assigned. Accordingly, the data including at least any of the respective image areas and the audio information can be transmitted to the respective reproduction devices for reproducing the image areas and the audio information on the respective surfaces through the mutually different channels, thus allowing achievement of simultaneously sharing the dynamic image and the audio information of the omnidirectional video by a large number of people in one virtual space.

Furthermore, according to the present invention, the features of the respective image areas and the spectator information including any one or more of the position, the gaze, and the direction of the head of the spectator, and the voice emitted from the spectator in the space are extracted. Therefore, the audio information can be interactively assigned to the respective surfaces based on the state of the spectator in response to the live video. Accordingly, the data including at least any of the respective image areas and the audio information can be transmitted to the respective reproduction devices for reproducing the image areas and the audio information on the respective surfaces through the mutually different channels, thus allowing achievement of simultaneously sharing the dynamic image and the audio information of the omnidirectional video by a large number of people in one virtual space.

### BRIEF DESCRIPTION OF THE DRAWINGS

FIG. 1 is a drawing illustrating an overall configuration of an image area generation system to which the present invention is applied.

FIG. 2 is a perspective view of a space surrounded by six rectangular surfaces.

FIG. 3 is a drawing illustrating an example of projection display of an image on a mutually common surface by a plurality of display devices.

FIG. 4 is a detailed block configuration diagram of a control device.

FIG. 5 is a flowchart illustrating respective operations of the image area generation system.

FIG. 6 is a drawing illustrating an example in which one image of static images constituting an omnidirectional moving image is illustrated on a rectangular plane.

FIG. 7 is a drawing illustrating an example of respective spherical image areas constituting an omnidirectional moving image taken by an omnidirectional imaging device.

FIG. 8 is drawings illustrating examples in which a static image constituting the omnidirectional moving image is divided into a plurality of image areas.

FIG. 9 is drawings illustrating examples in which the image area assigned to each surface is adjusted to have a rectangular shape.

FIG. 10 is a drawing illustrating an image of continuously transmitting data of the respective image areas on a time-series basis to display devices.

FIG. 11 is a drawing illustrating an example in which the respective image areas clipped from the omnidirectional moving image are displayed on the respective surfaces via the respective display devices.

FIG. 12 is drawings illustrating examples of a method for clipping the image area when the display device is configured by a projection display device that projects and displays the image area on the surface.

### DESCRIPTION OF PREFERRED EMBODIMENTS

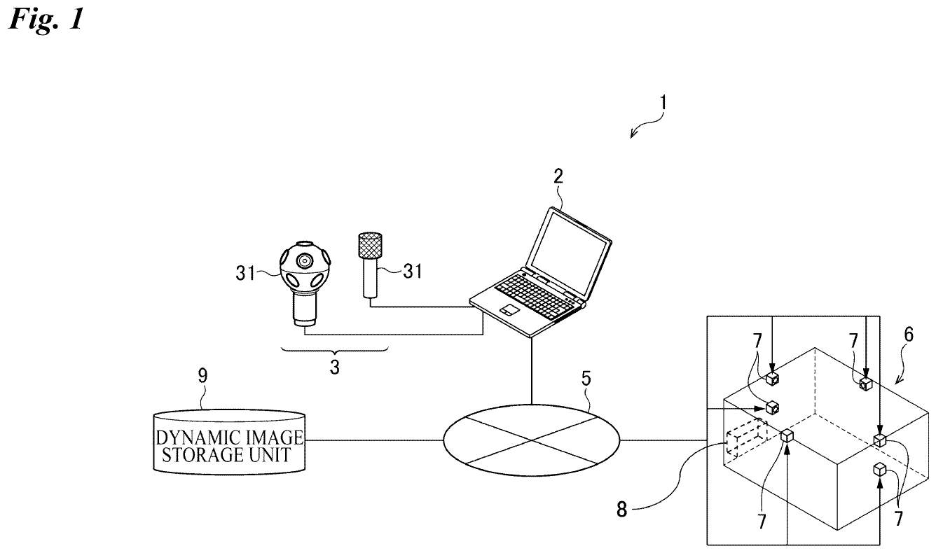

FIG. 1 illustrates an overall configuration diagram of an image area generation system 1 to which the present invention is applied. The image area generation system 1 includes a control device 2 as a main component and a recording module 3 connected thereto, and further includes display devices 7 that display a video and an audio device 8 that reproduces a sound, which are reproduction devices connected to the control device 2 via a communications network 5, and a dynamic image storage unit 9 that stores various kinds of video content, audio files, and the like. The image area generation system 1 may further include a space 6 in which the display devices 7 and the audio device 8 are provided. The spaces 6 may be provided, for example, at a plurality of bases individually or to be linked.

The control device 2 functions as what is called a central control instrument that controls the entire image area generation system 1. While the control device 2 is embodied as, for example, a personal computer (PC), it is not limited to this, and may be embodied as a server or dedicated equipment, or may be embodied as a portable information terminal, a tablet terminal, or the like.

The recording module 3 is used for preliminarily recording an alternative video based on a past event separately from a real event, and includes an omnidirectional imaging device 31 and a microphone 32.

The omnidirectional imaging device 31 is configured to simultaneously take an image in all directions (360° in the horizontal direction, 360° in the vertical direction) having an imaging device main body at the center without exception. By recording a moving image with the omnidirectional imaging device 31, the moving image in all directions (hereinafter referred to as an omnidirectional moving image) can be simultaneously taken without exception. Therefore, for example, when an image of an urban space is taken, in a case where a vehicle and a human move, dynamic images of the moving vehicle and human can be recorded on a time-series basis in all directions. While the omnidirectional imaging device 31 may be fixed at one position to continuously take the omnidirectional moving image, the omnidirectional imaging device 31 itself may be installed in a moving body including an unmanned aircraft, a vehicle, a helicopter, and the like to continue to record the omnidirectional moving image.

This allows obtaining a dynamic image as if a user were visually perceiving all directions while on board the moving body. The omnidirectional moving image taken by the omnidirectional imaging device 31 is output to the control device 2. The omnidirectional imaging device 31 is not limited to a case of being directly connected to the control device 2, and may be connected via a communications network (not illustrated) configured by an Internet network, a local area network (LAN), or the like.

The microphone 32 collects an ambient sound, and converts it to a sound signal. The microphone 32 transmits the converted sound signal to the control device 2 via an interface. The microphone 32 is necessary for achieving live video reproduction, but is not an especially required component, and may be omitted.

The communications network 5 is an Internet network or the like to which the control device 2, the display device 7, and a video device 8 are connected via communication lines. Incidentally, when the recording module 3, the control device 2, the display device 7, and the audio device 8 are operated in a certain narrow area, the communications network 5 may be configured by a LAN. The communications network 5 is not limited to a wired communication network, and may be achieved by a wireless communication network.

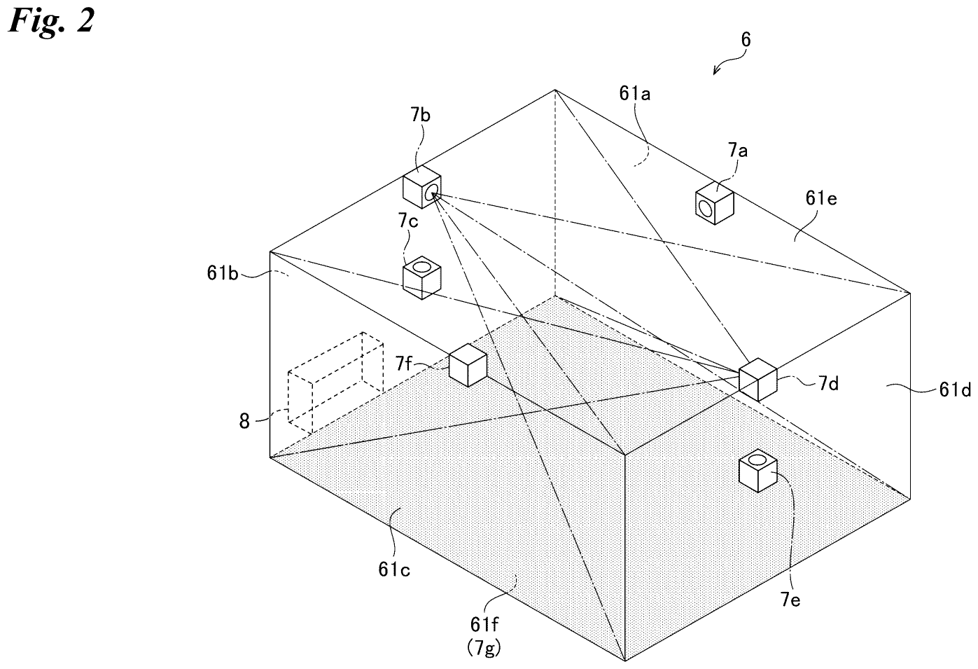

As illustrated in FIG. 2, the space 6 is configured by a space surrounded by six rectangular surfaces 61a to 61f. The space 6 includes, for example, the respective surfaces 61a to 61f corresponding to wall surfaces in four directions, a ceiling, and a floor like a room or the like. At this time, the space 6 may include a door (not illustrated) so as to allow a human to go in and out of the inside. The space 6 is not limited to a case of being configured by a completely closed space entirely surrounded by the six surfaces 61a to 61f, and the space 6 may be configured by an open space in which any one or more of the surfaces 61 are omitted, or may be configured by an open space in which any one or more of the surfaces 6 are further only partially open. The space 6 may be internally provided with various structures, such as various shapes, unevenness, a protrusion, and equipment, in addition to the surfaces 61a to 61f.

The image area generation system 1 reproduces a generated dynamic image and audio information corresponding to the dynamic image by the reproduction device. The reproduction device includes, for example, the display device 7 and the audio device 8. The display device 7 is configured by a projection display device that projects and displays an image area on the surface like what is called a projector. The display device 7 is not limited to a case of being configured by the projection display device, and may be configured by a display that displays the image area on the surface, for example, a liquid crystal display, an organic EL display, and further, an LED display.

When the display device 7 includes, for example, a speaker or the like that outputs a sound, music, and the like, the display device 7 may function as a device that reproduces audio. The display device 7 includes various speakers, and additionally, for example, may be coordinated with the audio device 8 separated from the display device 7. For example, when a sound is recorded and reproduced, the audio device 8 reproduces the sound based on three-dimensional direction, distance, diffusion, and the like of the sound.

The audio device 8 reproduces the sound as a 3D sound with a realistic sensation and a stereoscopic effect, for example, based on a plurality of elements constituting the sound. The plurality of elements include, for example, a “volume level difference” that reproduces sound image localization or the like of a sound source based on a sound volume attenuation or an interaural intensity difference due to a distance between the audio device 8 and an object (object person) or a distance inside a space, a “time difference” that reproduces the sound image localization or the like of the sound source based on, for example, a time difference of a sound wave reaching the object, a “frequency characteristic change” that reproduces the sound image localization or the like of the sound source based on a change of a frequency characteristic due to transmission or blocking of the sound wave, a “phase change” that reproduces the sound image localization or the like of the sound source based on a change of a phase due to transmission or blocking of the sound wave, and further, a “reverberation change” that reproduces a sound field or the like of a surrounding environment based on a reverberation characteristic.

The audio device 8 performs a rendering process of a stereophonic sound (3D sound) to control a sound field in a three-dimensional space of the space 6 based on a plurality of elements, for example, features of the respective image areas and spectator information, such as a position, a gaze, and a direction of the head of a spectator M, and a voice emitted from the spectator M in the space, for example, as a type of a dynamic image, such as a live video and an archived video, and shooting information. In the rendering process of the stereophonic sound, the audio device 8 performs the process by, for example, a publicly known feature prediction method and ray tracing method based on publicly known various kinds of processing and techniques, for example, a “feature prediction technique,” an “acoustic ray method/geometric acoustic modeling technique,” and “adaptive rectangular decomposition.”

The display device 7 and the audio device 8 function as reproduction devices that reproduce the dynamic image and the audio information, respectively. The control device 2 displays the image areas generated by the control device 2 on the respective surfaces 61a to 61f constituting the space 6 via the display devices 7 as illustrated in FIG. 2. In the case of the example of FIG. 2, a case where display devices 7a to 7f are configured by, for example, projection display devices as projectors, and a display device 7g is configured by an LED display is described as an example. A case where the audio device 8 is configured by, for example, a plurality of speaker units that reproduce the 3D sound and the stereophonic sound and installed on the back sides of the respective surfaces (for example, a back surface of the surface 61b) of the space 6 is described as an example. When the display devices 7a to 7f include speakers or the like, the audio device 8 may be configured to perform a reproduction together with them.

The display device 7a is installed in the proximity of an upper end of the surface 61a, and projects and displays an image on the surface 61c opposed to the surface 61a. The display device 7b is installed in the proximity of an upper end of the surface 61b, and projects and displays an image on the surface 61d opposed to the surface 61b. The display device 7c is installed in the middle of the surface 61b, the display device 7e is installed in the middle of the surface 61d, and the display device 7c and the display device 7e project and display an image on the common surface 61e. The display device 7d is installed in the proximity of an upper end of the surface 61d, and projects and displays an image on the surface 61b opposed to the surface 61d. The display device 7f is installed in the proximity of an upper end of the surface 61c, and projects and displays an image on the surface 61a opposed to the surface 61c. The display device 7g configured by an LED display displays an image on the surface 61f.

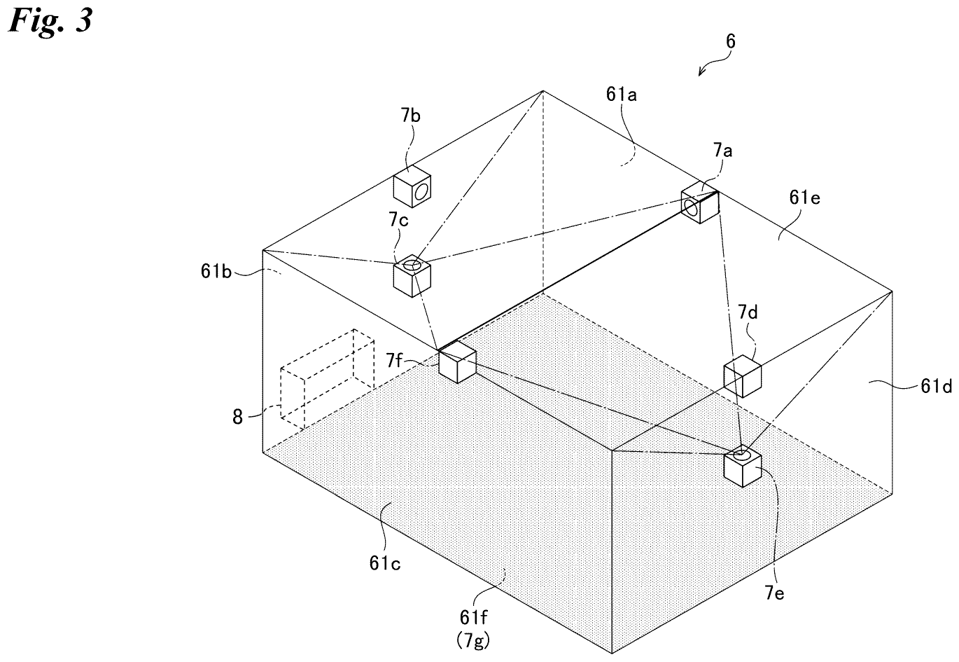

Combinations of the surface 61, on which the image is displayed, constituting the space 6 and the display device 7 that displays the image include any combination other than the above-described example. The combinations are not limited to a case where one display device 7 displays the image on each surface 61, and a plurality of the display devices 7 may be combined to display the image. FIG. 3 illustrates an example in which the display device 7c and the display device 7e project and display the image on the common surface 61e. That is, an area of one surface 61e is divided into halves, the display device 7c projects and displays the image on one area, and the display device 7e projects and displays the image on the other area. For the other surfaces 61, similarly, the area may be divided to cause the plurality of display devices 7 to project and display the image by dividing the image. In this case, the audio device 8 may determine each area of the surface divided into halves and reproduce the audio information corresponding to the image divided into the respective areas and displayed.

The audio device 8 reproduces the audio information corresponding to the acquired dynamic image. The audio device 8 may reproduce the audio information having a determined feature, for example, corresponding to the determination result of the features of the respective clipped image areas. This allows the audio device 8 to, for example, reproduce data including the audio information assigned to the respective reproduction devices and transmitted through mutually different channels as a 3D sound.

For example, one audio device 8 is installed on the back surface of the surface 61b, and reproduces a sound for the space 6 surrounded by the six rectangular surfaces 61a to 61f as a 3D sound. The audio device 8 may have a configuration, for example, in which a plurality of the audio devices 8 are installed on the six surfaces 61a to 61f (not illustrated). This allows reproduction of the three-dimensional direction, distance, diffusion, and the like of the sound corresponding to the dynamic image displayed in the space 6 surrounded by the six surfaces 61a to 61f.

The dynamic image storage unit 9 is a database for storing the dynamic images of at least any of the live video and the archived video to be displayed via the display device 7 and the audio information associated with the dynamic images. The dynamic image storage unit 9 preliminarily stores omnidirectional moving images including audio information already taken by another imaging device (not illustrated) other than the above-described omnidirectional imaging device 31. The various dynamic images including the audio information stored in the dynamic image storage unit 9 may be not only the above-described omnidirectional moving image and audio information but also ordinary two-dimensional moving images and audio information. The omnidirectional moving image stored in the dynamic image storage unit 9 is transmitted to the control device 2 via the communications network 5.

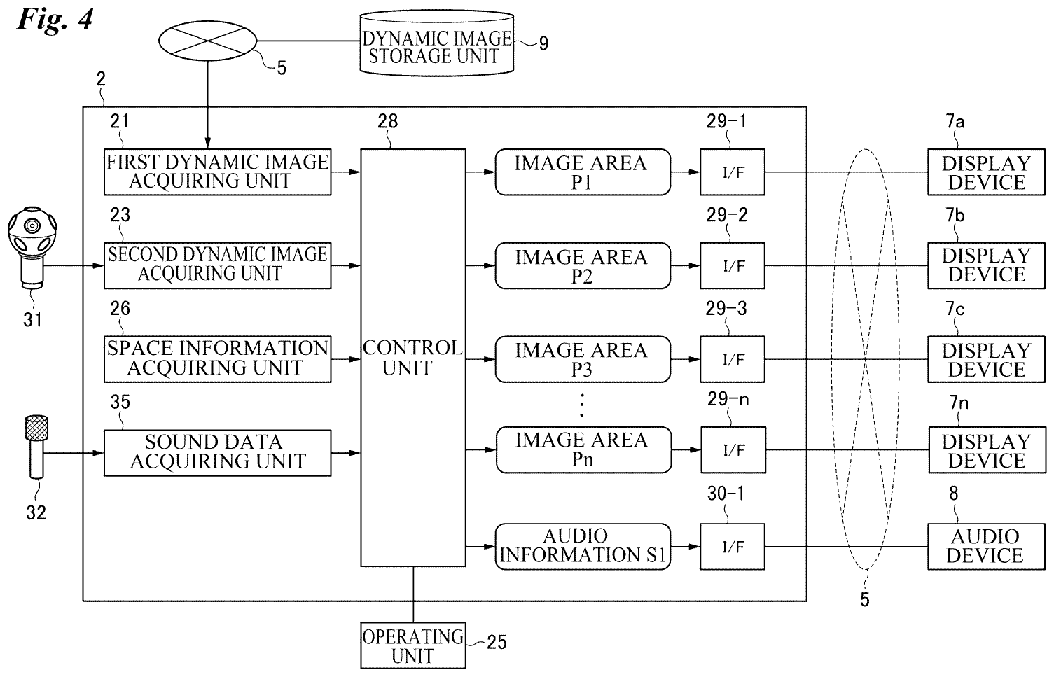

Next, the detailed block configuration of the control device 2 is described. The control device 2 includes, as illustrated in FIG. 4, a first dynamic image acquiring unit 21, a second dynamic image acquiring unit 23, a space information acquiring unit 26, a sound data acquiring unit 35, and an operating unit 25, and further includes a control unit 28 to which the first dynamic image acquiring unit 21, the second dynamic image acquiring unit 23, the space information acquiring unit 26, the sound data acquiring unit 35, and the operating unit 25 are each connected. Further, interfaces (I/Fs) 29-1, 29-2, 92-3, . . . 29-n for transmitting data of the respective image areas P1, P2, P3, . . . Pn to be output are connected to the control unit 28. Further, an I/F 30-1 for transmitting data of audio information S1 to be output is connected to the control unit 28. The audio information S1 may be, for example, configured to be connected to a plurality of display devices 7a, . . . , 7n and a plurality of audio devices 8 (not illustrated).

Since the control device 2 is configured by a PC or the like, in addition to these configurations, a central processing unit (CPU) as what is called a central processing unit for controlling respective components, a read only memory (ROM) that stores programs for controlling hardware resources of the entire control device 2, and a random access memory (RAM) used as a work area used for storing, decompressing, and the like of data are included, and an image processing unit or the like that performs various kinds of image processing on a 360-degree moving image and performs processing to clip the 360-degree moving image into the respective image areas P1 to Pn is additionally included.

The first dynamic image acquiring unit 21 acquires the omnidirectional moving image stored in the dynamic image storage unit 9 via the communications network 5. The first dynamic image acquiring unit 21 may acquire, for example, the dynamic image stored in the dynamic image storage unit 9 as the archived video or the like. The archived video may be a past dynamic image stored in each dynamic image server, for example, as a publicly known dynamic image providing service on the Web or the cloud. The dynamic image includes, for example, a voice, a background at the time of shooting, an ambient sound, music data added by a person of the shooting, or the audio information (2D/3D sound information, sound source information, acoustic facility information, sound effect information, set values, parameters, and the like), and the audio information may be associated with various kinds of music data and information individually or in common.

The second dynamic image acquiring unit 23 acquires the omnidirectional moving image taken by the omnidirectional imaging device 31. The second dynamic image acquiring unit 23 may acquire, for example, omnidirectional dynamic images of respective locations as live videos in real time by the omnidirectional imaging devices 31 (for example, fixed-point cameras and stationary cameras) installed at the respective locations. The second dynamic image acquiring unit 23 may acquire, for example, the dynamic image (a video of a human inside, motion sensor information indicating a position and a motion of a site of the human, or the like) inside the space 6 by the omnidirectional imaging device 31 installed inside the space 6 or a sensor or the like held by the spectator (not illustrated), such as another imaging device and a sensor.

For example, a plurality of the omnidirectional imaging devices 31 may be installed in a plurality of the spaces 6, and may acquire various kinds of information, such as a position, a gaze, a direction of the head of the human (spectator M) inside, and a voice emitted from the spectator, individually or together as spectator information.

The second dynamic image acquiring unit 23 may acquire various kinds of information and data, for example, position information of a location at which the omnidirectional imaging device 31 is installed, environment information of the periphery, the date and time of shooting, and the weather, together. The dynamic image acquired by the second dynamic image acquiring unit 23 may be, for example, stored in the dynamic image storage unit 9 via the communications network 5 by the control unit 28.

The space information acquiring unit 26 acquires various kinds of information on the space 6 in which the image areas P1 to Pn are actually displayed and the space 6. The space information acquiring unit 26 acquires various kinds of information on the shape of the space 6, such as a vertical/horizontal size ratio between the respective surfaces 61 of the space 6. The information acquired by the space information acquiring unit 26 includes information on the arrangement of the display devices 7 installed on the respective surfaces 61 of the space 6, and not only information on which display device 7 displays the image on each surface 61 when one display device 7 displays the image on each surface 61 as described above, but also information on the assignment when the plurality of display devices 7 are combined to display the image on each surface 61.

Further, the space information acquiring unit 26 acquires various kinds of information on the space 6 in which the audio information S1 is actually provided. The space information acquiring unit 26 acquires various kinds of information on the shape, the material, an echo object, and the like of the space 6, such as a vertical/horizontal size ratio between the respective surfaces 61 of the space 6. The information acquired by the space information acquiring unit 26 includes information on the arrangement of the audio devices 8 installed on the respective surfaces 61 of the space 6, and not only information on which audio device 8 provides the audio information to the spectator in the space 6 when one audio device 8 provides the audio information to each surface 61 as described above, but also various kinds of information on the assignment, the timing, the directionality, and the like when the audio information is provided to each surface 61 in combination of individual audio modules (audio units) constituting the audio device 8 and the plurality of display devices 7.

When the display device 7 is configured as a projection display device or a reproduction device combined with the audio device 8, the space information acquiring unit 26 may acquire information on a positional relation, or a projection direction, a view angle, and the like with respect to the surface 61 of each projection display device or reproduction device. The space information acquiring unit 26 transmits the acquired information on the space 6 to the control unit 28.

Further, when one or a plurality of audio devices 8 and the display devices 7 are combined to be configured as reproduction devices, the space information acquiring unit 26 may acquire information on a positional relation, or the directionality of the audio devices 8 to the space 6, the surfaces 61, and the spectator, the intensity of the 3D sound, and the like. The space information acquiring unit 26 transmits the acquired information on the space 6, the surface 61, the spectator, and the like to the control unit 28. For the information on the spectator and the like, assumed spectator information that is preliminarily set may be transmitted to the control unit 28.

The sound data acquiring unit 35 acquires sounds through the microphone 32 or the like, and stores them. For a method for acquiring a sound through the microphone 32, for example, the sound may be wiredly or wirelessly acquired from a public communications network, or sound data recorded in a recording medium may be read and recorded. The sound data acquiring unit 35 may acquire, for example, in addition to the sound, various kinds of music and BGM, or sound information and audio data at the location of the microphone 32. The sound data acquiring unit 35 may acquire sound data of a plurality of sound sources via a plurality of the microphones 32 or the like.

The sound data acquiring unit 35 may, for example, acquire the dynamic image inside the space 6 (a video of a human inside, motion sensor information indicating a position and a motion of a site of the human, or the like) by a microphone included in the omnidirectional imaging device 31 installed in the space 6, another microphone 32, or a microphone or the like held by the spectator (not illustrated). For example, a plurality of the omnidirectional imaging devices 31 may be installed in the plurality of spaces 6, and may acquire various kinds of information, such as a position, a gaze, a direction of the head of the human (spectator M) inside, and a voice emitted from the spectator, individually or together as spectator information.

The operating unit 25 is embodied by a keyboard or a touch panel, and execution instructions for executing the program are input from the user. When the execution instructions are input from the user, the operating unit 25 notifies the control unit 28 of it. The control unit 28 that has received the notification executes a desired processing operation in cooperation with the respective components including a determining unit 27.

The control unit 28 is what is called a central control unit that transmits a control signal via an internal bus to control the respective components implemented in the control device 2. The control unit 28 transmits commands for various kinds of control through the internal bus corresponding to the operation via the operating unit 25. The control unit 28 accepts the input of various kinds of data of the dynamic image and the audio information from each of the first dynamic image acquiring unit 21 and the second dynamic image acquiring unit 23.

The control unit 28 clips respective static images constituting the dynamic image whose input has been accepted into the plurality of image areas P1, P2, . . . , Pn as described later. Data of the dynamic image including the clipped image areas P1, P2, . . . , Pn is transmitted through mutually different channels via the I/Fs 29-1, 29-2, . . . , 29-n, respectively. The control unit 28 clips respective static images constituting the dynamic image whose input has been accepted into the plurality of image areas P1, P2, . . . , Pn as described later. Data of the dynamic image including the clipped image areas P1, P2, . . . , Pn is transmitted through mutually different channels via the I/Fs 29-1, 29-2, . . . , 29-n, respectively. Further, as described later, for the audio data constituting the audio information whose input has been accepted, the control unit 28 transmits the audio information S1 through a channel different from data of a different dynamic image via the I/F 30-1.

Each of the I/Fs 29-1, 29-2, . . . , 29-n and the I/F 30-1 functions as an interface for establishing a communication link between the control device 2, the display device 7, and the audio device 8 as a reproduction device. The I/Fs 29-1, 29-2, . . . , 29-n and the I/F 30-1 are not limited to a case where the I/Fs 29-1, 29-2, . . . , 29-n are individually provided to the plurality of image areas P1, P2, . . . , Pn clipped by the control unit 28 and the I/Fs 30-1 are individually provided to a plurality of pieces of the audio information S1 clipped by the control unit 28, and may be configured as a common interface unit.

Next, an operation of the image area generation system 1 configured as described above to which the present invention is applied is described.

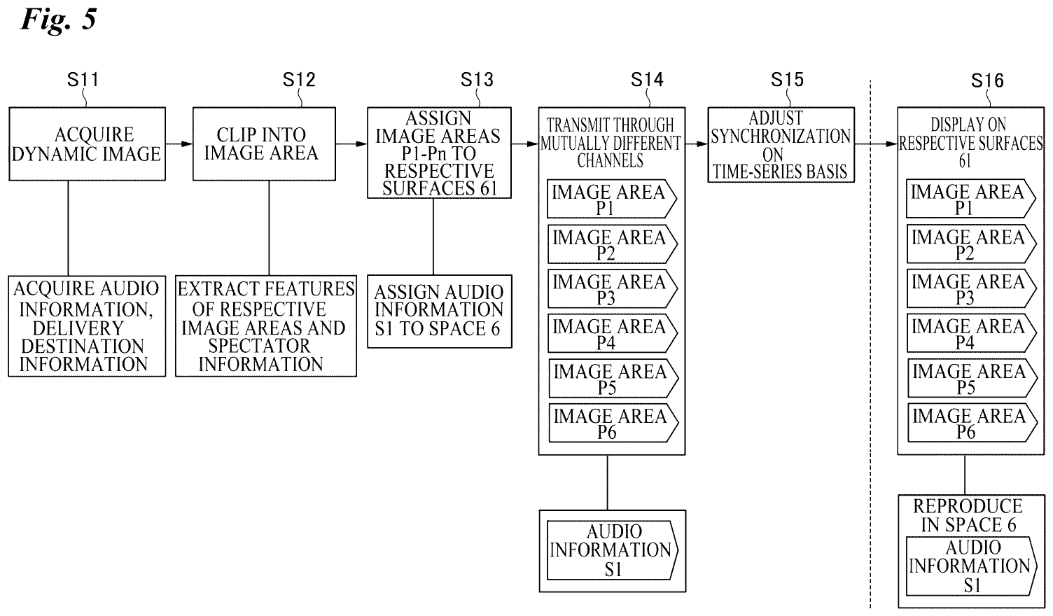

FIG. 5 is a flowchart illustrating respective operations of the image area generation system 1. First, in Step S11, the control device 2 acquires a dynamic image. The dynamic image acquisition by the control device 2 is performed via the first dynamic image acquiring unit 21 and the second dynamic image acquiring unit 23 described above. That is, when an omnidirectional moving image stored in the dynamic image storage unit 9 is transmitted via the communications network 5, it is acquired via the first dynamic image acquiring unit 21. When an omnidirectional moving image is taken via the omnidirectional imaging device 31, it is acquired via the second dynamic image acquiring unit 23.

In Step S11, the control device 2 acquires audio information and delivery destination information relating to the 360-degree moving image in addition to the omnidirectional moving image. For example, the control device 2 may individually acquire the audio information relating to the dynamic image and the delivery destination information for delivering the dynamic image and the audio information, or collectively acquire them by including them in the 360-degree moving image.

The acquisition of the 360-degree moving image (dynamic image), the audio information, and the delivery destination information by the control device 2 is performed via the first dynamic image acquiring unit 21 and the second dynamic image acquiring unit 23 described above. For example, when an omnidirectional moving image stored in the dynamic image storage unit 9 is transmitted via the communications network 5, the control device 2 acquires it via the first dynamic image acquiring unit 21, and when an omnidirectional moving image is taken via the omnidirectional imaging device 31, the control device 2 acquires it via the second dynamic image acquiring unit 23.

When the omnidirectional moving image and the 360-degree moving image acquired by the first dynamic image acquiring unit 21 and the second dynamic image acquiring unit 23 include various kinds of information, such as the audio information and the delivery destination information, the information may be transmitted to the control unit 28 together. The delivery destination information includes, for example, various kinds of information relating to the delivery of the 360-degree moving image. The delivery destination information may include, for example, deliverable contract information (distribution conditions, billing information, point information, and the like), deliverable facility information (information on the space 6, projection facility information, acoustic facility information, illumination information, and the like), deliverable customer information relating to the spectator (member information, gender, age, height, hobby information, information on a group or the like), and motion information indicating a gaze, a posture, a motion, and the like of the customer acquired in real time in the 360-degree moving image inside the space 6.

In the omnidirectional moving image transmitted from the first dynamic image acquiring unit 21 and the second dynamic image acquiring unit 23, the control unit 28 clips the image areas for each static image constituting the omnidirectional moving image as described below (Step S12).

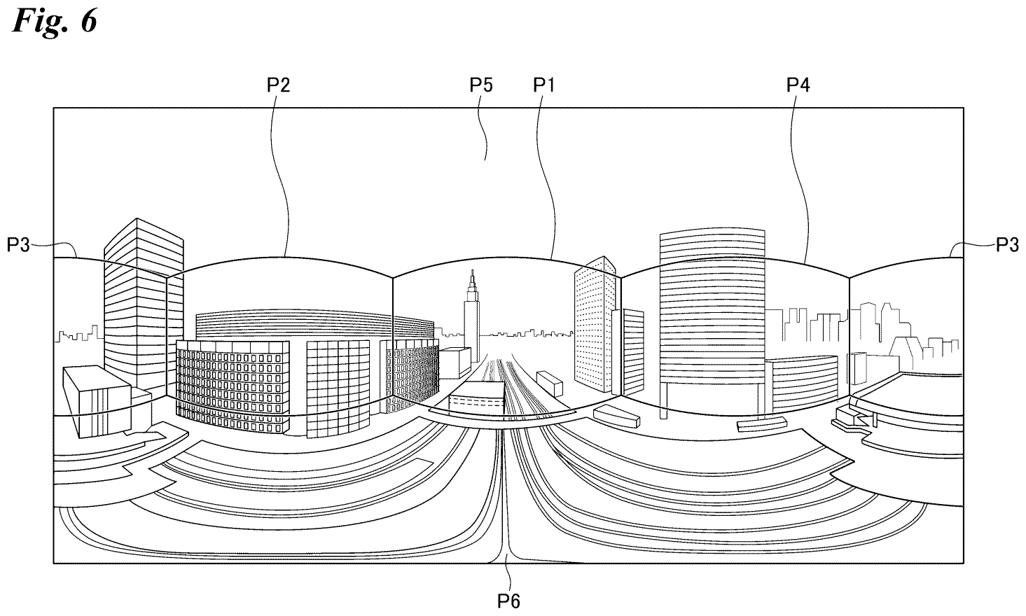

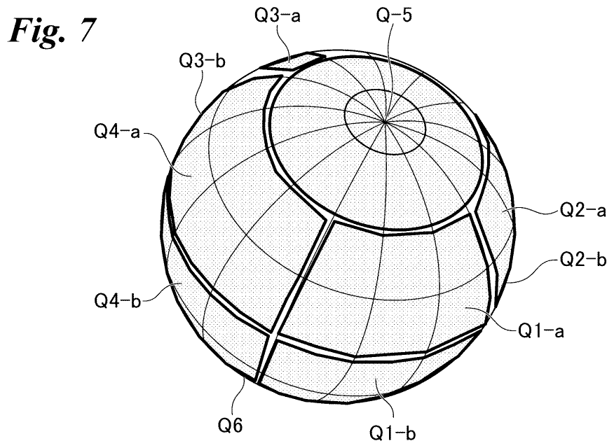

FIG. 6 illustrates one image of the static images constituting the omnidirectional moving image on a rectangular plane. The respective static images constituting the omnidirectional moving image taken by the omnidirectional imaging device 31 can be divided into respective spherical image areas Q1-a, Q1-b, Q2-a, Q2-b, Q3-a, Q3-b, Q4-a, Q4-b, Q5, Q6 constituting a spherical surface as a whole as illustrated in FIG. 7. FIG. 6 illustrates the spherical image areas Q1-a, Q1-b, Q2-a, Q2-b, Q3-a, Q3-b, Q4-a, Q4-b, Q5, Q6 planarly drawn again as the static image constituting the omnidirectional moving image.

The control unit 28 clips the image areas P1, P2, . . . , Pn in the drawing for each of the static images constituting the omnidirectional moving image. In the example of FIG. 6, six image areas P1 to P6 are clipped. For example, when clipping the image areas P1, P2, . . . , Pn, the control unit 28 may clip each of the static images constituting the dynamic image into a plurality of the image areas corresponding to the positional relation between the respective surfaces based on the various kinds of information included in the delivery destination information and the audio information.

The control unit 28 further includes, for example, an extracting unit. For example, the extracting unit determines a feature of the displayed dynamic image from the respective clipped image areas, and extracts spectator information including the determined features of the respective image areas and any one or more of a position, a gaze, and a direction of the head of the spectator, and a voice emitted from the spectator in real time inside the space 6. For example, the extracting unit acquires the motion information indicating the feature of various kinds of information (spectator information), such as a position, a gaze, and a direction of the head of the spectator, and a voice emitted from the spectator M inside the space 6, using the second dynamic image acquiring unit 23 or another publicly known sensor, and performs identification by the process of image identification, voice identification, and the like, thereby extracting the motion information indicating the gaze, the posture, and the motion of each spectator in real time. For example, the extracting unit stores the respective image areas (still images or moving images) inside the space 6 in the dynamic image storage unit 9 in association with the real-time motion information of the spectator.

Simultaneously with the clipping process of the image areas P1 to P6, or after the end of the clipping process, the respective clipped image areas P1 to P6 are assigned to the respective surfaces 61a to 61f (Step S13). The image area P1 is assigned to the surface 61a illustrated in FIG. 2, the image area P2 is assigned to the surface 61b, the image area P3 is assigned to the surface 61c, the image area P4 is assigned to the surface 61d, the image area P5 is assigned to the surface 61e, and the image area P6 is assigned to the surface 61f. That is, in this clipping example, the image areas P are assigned to the respective surfaces 61, respectively. Provisionally, when a plurality of the image areas P are combined to be displayed on one surface 61, similarly, the plurality of image areas P to be displayed are assigned to the one surface 61.

Furthermore, simultaneously with the assignment of the respective image areas P1 to P6 to the respective surfaces 61a to 61f, the audio information S1 is assigned to the audio device 8 illustrated in FIG. 2. For example, when speakers of the respective display devices 7a to 7n and another audio reproduction device (not illustrated) are set in addition to the audio device 8, the control unit 28, for example, divides the audio information S1 in accordance with the clipping process of the image areas P1 to P6, and assigns it to a plurality of respective audio devices.

For example, the control unit 28 may assign the respective image areas to the respective surfaces based on information on the extracted features of the respective image areas and the audio information, features of the space 6 and the like (size, material, the number of viewers, characteristics, and the like), and the like, and further, the control unit 28 may assign the whole (for a crowd) or a part (for a specific person, children, adults, by charge, and the like) of the audio information reproduced in the space 6 to the entire space 6 or individually to the respective surfaces.

For example, the control unit 28 may clip the respective static images constituting the dynamic image into a plurality of the image areas corresponding to the length and the effect of the acquired audio information according to the positional relation of the respective surfaces, and assign the respective clipped image areas P1 to P6 to the respective surfaces 61a to 61f. Furthermore, for example, the control unit 28 may obtain the directionality of the acquired audio information with respect to the respective assigned surfaces 61a to 61f, and assign a reproduction timing, a reproduction pattern, a sound effect, and the like of the audio information so as to allow the reproduction in the space 6. This allows reliably reproducing the audio information together with the dynamic image precisely to the spectator M in the space 6.

Furthermore, for example, the control unit 28 may clip the respective static images additionally constituting the dynamic image into a plurality of image areas based on the features of the respective image areas extracted by the extracting unit and the spectator information (motion information) including any one or more of the position, the gaze, and the direction of the head of the spectator, and the voice emitted from the spectator inside the space 6 according to the positional relation of the respective surfaces, and assign the respective clipped image areas P1 to P6 to the respective surfaces 61a to 61f. This allows interactively assigning the 360-degree image and the audio information to the respective surfaces based on the motion of the spectator in response to the live video delivered in the space 6.

The static image constituting the omnidirectional moving image is thus divided into the plurality of image areas P without a remaining part. The shape of a boundary between the image areas P is determined based on the vertical/horizontal size ratio between the respective surfaces 61. Similarly, the audio information corresponding to the static image is also assigned based on the plurality of divided image areas P.

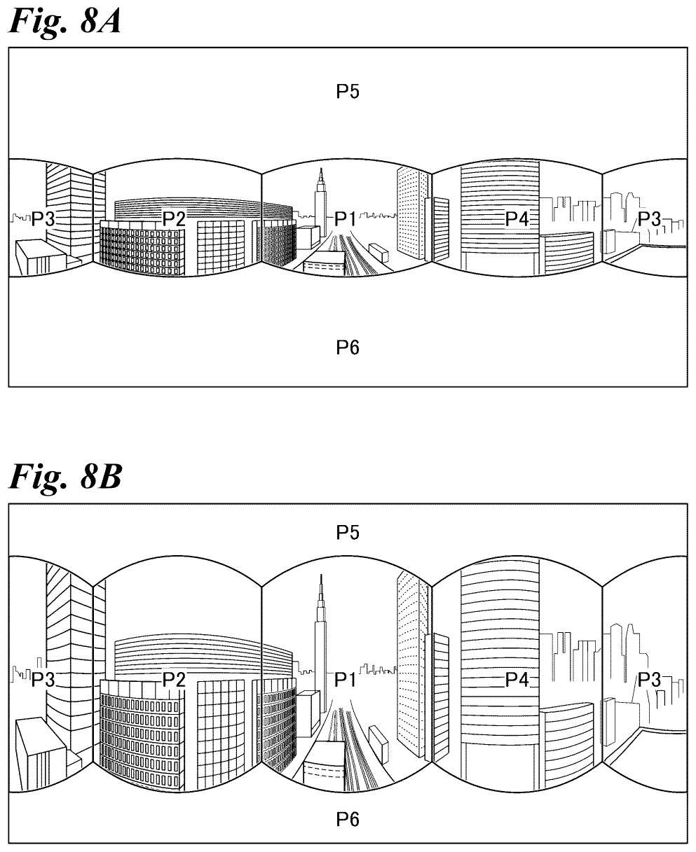

For example, it is assumed that the boundaries between the image areas P1 to P6 illustrated in FIG. 8A correspond to the vertical/horizontal size ratios between the surfaces 61a to 61f of one space 6. At this time, when another space 6 is smaller than the one space 6 in area, and the vertical/horizontal size ratios between the surfaces 61a to 61d are different from those in the one space 6, for example, as illustrated in FIG. 8B, the boundaries between the image areas P1 to P4 are adjusted to extend in an up-down direction, and the boundaries between the image areas P5, P6 are adjusted to have a shape compressed in the up-down direction.

For example, the audio information is adjusted as the audio information provided in the space 6 as the audio information S1 corresponding to the adjusted shape and move of these image areas, and reproduced by the audio device 8. For example, when the respective display devices 7a to 7n include speakers or the like, the audio information may be reproduced from the speakers. Furthermore, when the audio device 8, the speakers of the respective display devices 7a to 7n, and a plurality of other audio reproduction devices (not illustrated) are provided in the space 6, the audio information is controlled and reproduced as the audio information for the respective surfaces 61a to 61f by the control unit 8.

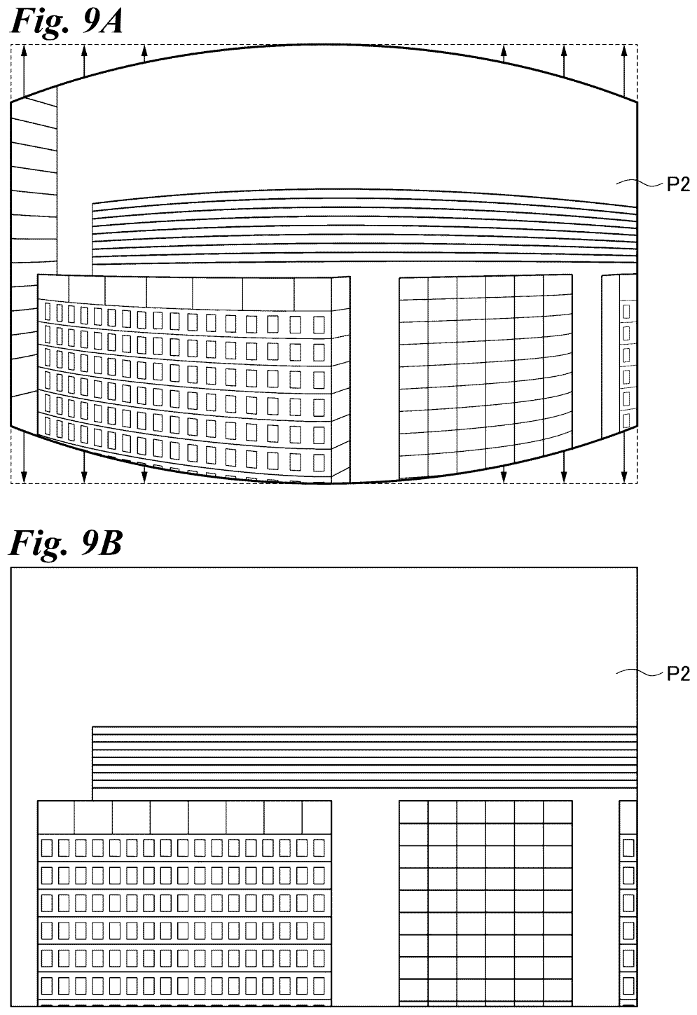

In this Step S13, the image areas P1 to P6 assigned to the respective surfaces 61 may be adjusted such that each of the image areas P1 to P6 has a rectangular shape. In this case, as illustrated in FIG. 9A, in a case of an example of the image area P2, by performing image processing of elongating upper and lower ends of the image area P2 in arrow directions toward dotted line sides in the drawing, the image area P2 processed in a rectangular shape as illustrated in FIG. 9B can be obtained.

Next, the process proceeds to Step S14, and the control unit 28 transmits the generated image areas P1 to Pn through mutually different channels via the I/Fs 29 and the audio information S1. Here, the channel means a communication line. That is, transmitting through different channels means that the data of the image areas P1 to Pn and the audio information S1 is separately transmitted by mutually different communication lines. Then, the data of the image areas P1 to Pn and the audio information S1 divided into the respective communication lines is directly mutually independently transmitted to the respective reproduction devices that are the display devices 7 and the audio device 8 (or individual audio modules constituting the audio device 8).

In the example of FIG. 4, the image area P1 is independently transmitted toward the display device 7a, the image area P2 is independently transmitted toward the display device 7b, the image area P3 is independently transmitted toward the display device 7c, and the image area Pn is independently transmitted toward the display device 7n. During this, the data of the respective image areas P1 to Pn is transmitted to the display devices 7 through mutually independent communication paths without being mutually collected at one place. Further, the audio information S1 is independently transmitted toward the audio device 8. The respective image areas P1 to Pn independently transmitted toward the display devices 7a to 7n respectively may be transmitted with, for example, the audio information S1 or individually segmented audio information constituting the audio information S1 included therein.

The original omnidirectional moving image includes a large amount of static images in each second at a preliminarily set frame rate (24 fps, 30 fps, 60 fps, or the like). Continuously transmitting the image areas P1 to Pn into which such a large amount of static images are divided on a time-series basis requires a considerable volume of communication. When the continuous transmission of the image areas P1 to Pn is performed by one communication path, a considerable communication time is required, and the communication cost becomes excessive. In view of this, in the present invention, the image areas P1 to Pn are transmitted toward the display devices 7 and the audio device 8 that provides the audio information S1, or the reproduction devices configured by the display device 7 and the audio device 8 via the mutually different communication paths, thereby allowing the reduction of the transmission rate of the image area P at the individual communication path, and consequently allowing the transmission of the data of the image area P toward the display device 7 at high speed and low cost.

The image areas P1 to Pn and the audio information S1 may be transmitted toward the display devices 7 and the audio device 8, or the reproduction devices further by using different frequency channels in addition to using the different communication paths. Accordingly, by using the different frequency channels, the image areas P1 to Pn can be transmitted toward the display devices 7 and the audio device 8, or the reproduction devices with high communication quality without mutual interference.

Next, the process proceeds to Step S15, and an adjustment to mutually synchronize the respective image areas of the data transmitted toward the display devices 7 and the audio device 8 on a time-series basis is performed.

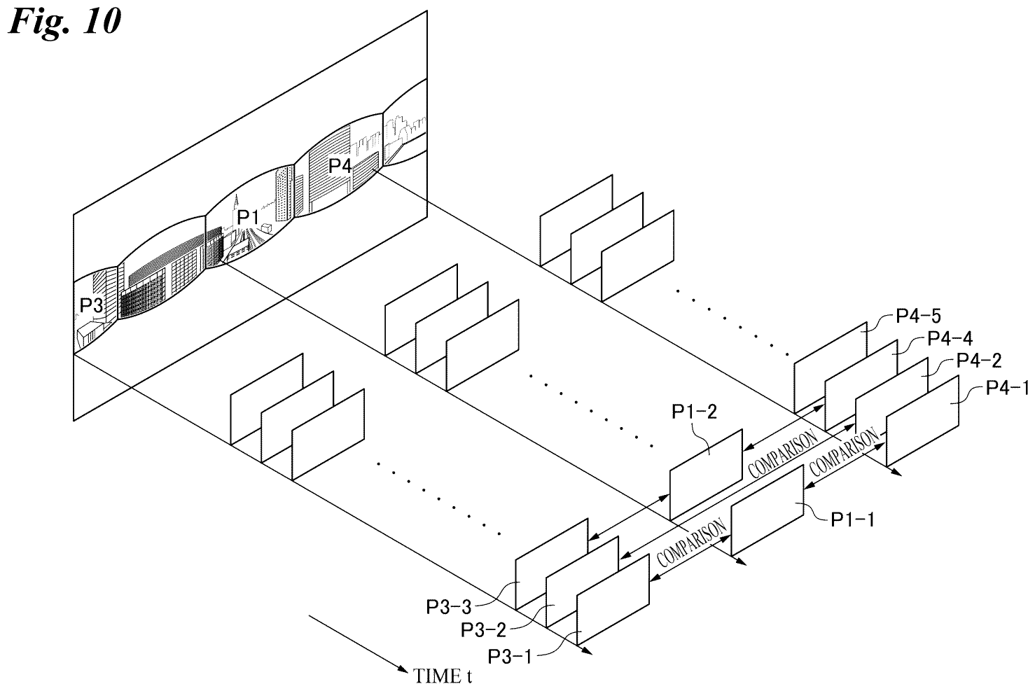

FIG. 10 illustrates an image of continuously transmitting the data of the respective image areas P1 to Pn to the display devices 7 on a time-series basis. The data of the respective image areas P1 to Pn clipped from the static image constituting the omnidirectional moving image is sequentially transmitted to the display devices 7. For the next static image constituting the omnidirectional moving image, the image areas P1 to Pn are similarly clipped and transmitted to the display devices 7. By repeatedly executing this, the respective image areas P1 to Pn are transmitted from the beginning of a frame with respect to an axis of a time t as illustrated in FIG. 10.

Time-series identification information may be sequentially added to data streams of the respective image areas P1 to Pn thus transmitted corresponding to the axis of the time t. The time-series identification information may be what is called a time stamp, and may be added corresponding to the time at which the image areas P1 to Pn are generated. The time-series identification information may correspond to a frame number sequentially added to each static image constituting the omnidirectional moving image on a time-series basis. That is, the image areas P1 to Pn clipped from the frame of the same static image may be provided with the time-series identification information corresponding to the same frame number.

Accordingly, by the synchronization on a time-series basis between the image areas P1 to Pn to which the time-series identification information corresponding to the same frame number is added, the image areas P1 to Pn can be displayed without a gap.

In FIG. 10, for convenience, “#” of Pn-# is assumed as the time-series identification information. The time-oriented identification information is added in order of 1, 2, 3, . . . , #, . . . from oldest.

As illustrated in FIG. 10, for example, for the synchronization between the image areas P1, P3, P4, the time-series identification information of the image areas P1-1, P3-1, P4-1 transmitted at first is identified, thereby confirming whether or not they are mutually matched on a time-series basis.

For example, in a case where the time-series identification information corresponds to the frame number sequentially added to the static images constituting the omnidirectional moving image, when the time-series identification information corresponding to the frame number is common, it can be determined that the synchronization therebetween on a time-series basis is made. On the premise that the time-series identification information corresponds to the time at which the image areas P1 to Pn are generated, and the generation times of the image areas P1 to Pn can be assumed to be always mutually the same without a gap, when the time-series identification information is common, it can be determined that the synchronization therebetween on a time-series basis is made.

As a result of the identification of the time-series identification information added to the ends of the image areas P1-1, P3-1, P4-1 transmitted at first, since the time-series identification information is mutually the same, it can be determined that the synchronization therebetween on a time-series basis is made. It is assumed that at the next timing, while the time-oriented identification information is common to the image areas P3-2, P4-2, the image area P1 is absent. In such a case, it can be determined that the image areas P are not mutually synchronized. In a case where the image area P3-3 is not matched with the image areas P1-2, P4-4 in time-series identification information added to the ends thereof at the further next timing, it can be determined that the image areas P are not mutually synchronized as well.

As a result of the determination using the time-series identification information, when it is determined that the mutual synchronization is not made, the adjustment to mutually synchronize the respective image areas P1 to Pn on a time-series basis is performed. For example, as described above, in a case where while the time-oriented identification information is common to the image areas P3-2, P4-2, the image area P1 is absent at the same timing, and the image area P1-2 is associate with the image area P3-3 at a later timing, the adjustment is performed to associate the image area P1-2 with the image areas P3-2, P4-2 matched in the time-oriented identification information, thereby making the synchronization. Alternatively, when the image area P1-2 itself to be at the same timing as the image areas P3-2, P4-2 is completely absent, the image area P1-2 itself may be additionally generated. In this case, the absent image area P1-2 may be generated by interpolating pixels based on the previous and next image areas P1-1, P1-3 using a well-known technique, or any of the previous and next image areas P1-1, P1-3 may be directly inserted.

The adjustment itself for the synchronization using the time-series identification information in Step S15 may be performed via a server (not illustrated) provided in the communications network 5, or may be performed between the display devices 7 actually receiving the data of the image areas P1 to Pn. When the adjustment for the synchronization is performed between the display devices 7, it may be achieved by communication between the display devices 7. The adjustment itself for the synchronization using the time-series identification information may be performed in the control device 2. In any case, since the data of the image areas P1 to Pn is transmitted through the mutually different channels, the adjustment for the synchronization is performed in the control device 2 before the transmission, between the respective display devices 7 after the transmission, or in the communications network 5.

In Step S15, in accordance with the transmission of the data of the respective adjusted image areas P1 to Pn and respective pieces of data to the display devices 7, the audio information S1 is transmitted to the audio device 8. The audio information S1 is clipped, for example, for each certain time period, or for each time period or for each effect corresponding to a spatial characteristic, an audio type, spectator information, or the like, and transmitted to the audio device 8. By repeatedly executing them also for the audio information S1, as illustrated in FIG. 10, the audio information S1 is transmitted in accordance with the beginning of the frame of the respective image areas P1 to Pn with respect to the axis of the time t.

For the respective image areas P1 to Pn and the audio information S1, the adjustment itself for the synchronization using the time-series identification information may be performed via a server (not illustrated) provided in the communications network 5, or may be performed by the display devices 7 and the audio device 8, or the reproduction devices actually receiving the data of the image areas P1 to Pn and the audio information S1.

The data of the image areas P and the audio information S1 mutually synchronized on a time-series basis as described above is transmitted to the respective display devices 7 and the audio device 8, or the reproduction devices that display the assigned surfaces 61.

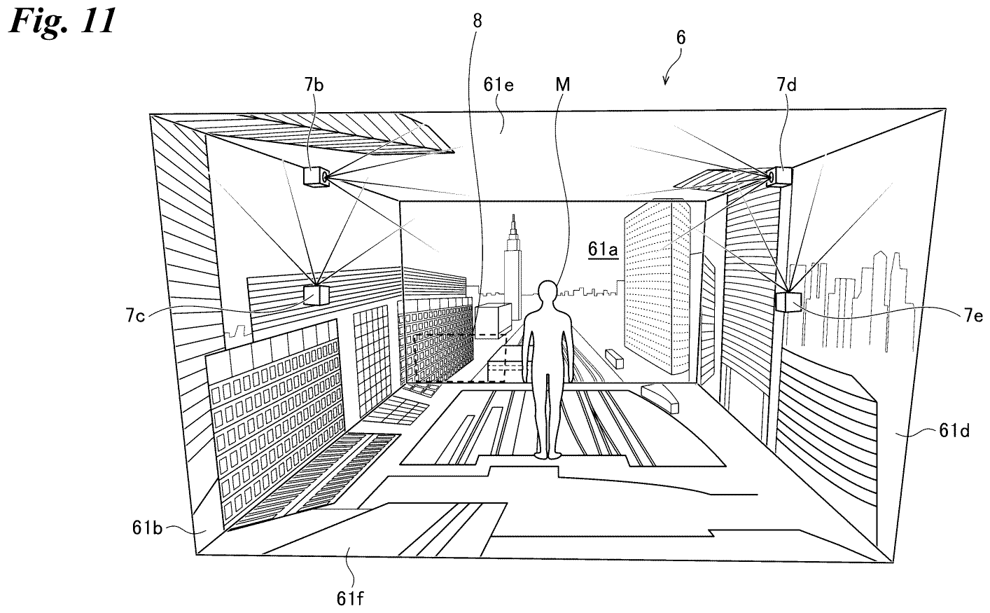

The respective display devices 7 display the image areas P on the respective surfaces 61 (Step S16). Which of the display devices 7a to 7g displays the image on the respective surfaces 61a to 61f has been already determined. Therefore, the image areas P1 to Pn assigned to the respective surfaces 61a to 61f are transmitted to the display devices 7a to 7g that display the surfaces 61, and displayed. Accordingly, as illustrated in FIG. 11, the respective image areas P1 to Pn clipped from the omnidirectional moving image are displayed on the respective surfaces 61a to 61f via the respective display devices 7a to 7g.

Furthermore, the audio device 8 is installed on the back sides or the like of the respective surfaces 61a to 61f with respect to the respective display devices 7a to 7g to provide the audio information S1 to the space 6 and the respective surfaces 61. Which of the display devices 7a to 7g on the respective surfaces 61a to 61f in the space 6 the audio information is provided to via the audio device 8 may have been already determined, and this allows providing the audio information appropriate for the space 6 and the image areas P1 to Pn assigned to the respective surfaces 61a to 61f corresponding to the display devices 7a to 7g that display the surfaces 61. Accordingly, as illustrated in FIG. 11, the audio information synchronized with the space 6 and the respective surfaces 61a to 61f can be reproduced via the audio device 8 corresponding to the respective image areas P1 to Pn clipped from the omnidirectional moving image.

When the spectator M enters the space 6, the spectator M can view the image areas P1 to Pn displayed on respective surfaces 61a to 61g. Since the image areas P1 to Pn are originally clipped from the omnidirectional moving image into six surfaces, by visually perceiving the image areas P1 to Pn displayed on the respective surfaces 61a to 61g, the spectator M in the space 6 can enjoy a feeling as if the spectator M were standing at the center of the omnidirectional moving image. By visually perceiving the respective surfaces 61a to 61g, the spectator M sees the image area P displayed on the visually perceived surface 61. That is, since the image area P corresponding to a visually perceived direction is seen, a feeling similar to that of VR can be obtained. Moreover, without wearing a glasses type or goggles type head-mounted video display device necessary for experiencing VR, a realistic sensation as if the spectator M themselves were actually present at a place can be experienced in the space 6. Therefore, an oppressive feeling and inconvenience due to the wearing of the head-mounted video display device and an effort to put on the device can be eliminated. Further, an influence on the body such as what is called VR sickness due to a gap between information visually obtained via the head-mounted video display device and information that the real body receives is also eliminated.

Furthermore, the experience of the image areas P1 to Pn displayed on the respective surfaces 61a to 61g together with the audio information S1 allows the spectator M in the space 6 to enjoy the feeling as if the spectator M were standing at the center of the omnidirectional moving image with the video and the sound (stereophonic sound, 3D sound). By watching and listening to the respective surfaces 61a to 61g together with the audio information, the spectator M can experience the image area P as the display of the watched surface 61 and the audio information S1. That is, since the image area P and the audio information corresponding to the visually perceived direction are watched and listened to, a feeling similar to that of a real experience can be obtained in the space 6. Moreover, without wearing a glasses type or goggles type head-mounted video display device necessary for experiencing VR, a realistic sensation as if the spectator M themselves were actually present at a place can be experienced in the space 6 by the 3D sound provided by the audio device 8. Therefore, an oppressive feeling and inconvenience due to the wearing of the head-mounted video display device and an effort to put on the device can be eliminated. Further, an influence on the body such as what is called VR sickness due to a gap between information visually obtained via the head-mounted video display device and information that the real body receives is also eliminated.

Furthermore, according to the present invention, a plurality of the spectators M can simultaneously enter the space 6 and watch and listen to the common image area P and audio information S1, thus allowing achievement of simultaneously sharing the omnidirectional video and the sound by a large number of people in one virtual space, which cannot be achieved with conventional VR. Further, for example, since the common image area P and audio information S1 can be transmitted to another base via the communications network 5, the common image area P and audio information S1 are simultaneously watched and listened to at a plurality of bases, thereby allowing enjoying them at each space 6.

According to the present invention, the respective image areas P1 to Pn can be independently transmitted to the display devices 7a to 7f through the mutually different communication paths, thereby allowing providing content to the space 6 at high speed and low cost. Moreover, a mismatch on a time-series basis between the respective image areas P1 to Pn possibly generated by independently transmitting the respective image areas P1 to Pn through the mutually different communication paths can be eliminated by the synchronization adjustment process in Step S15.

The space 6 surrounded by the respective surfaces 61 has various shapes and sizes depending on the situation of an actual site, and it is necessary to freely achieve optimal clipping of the image area P corresponding to the space 6 according to the circumstances. Since the image areas P to be assigned to the respective surfaces 61 can be clipped based on the vertical/horizontal size ratio between the respective surfaces 61, the present invention can deal with the variety of the shape of the space 6.

In this case, when there is a space 6 in which the image area P plans to be additionally displayed, an imaging device is installed in the space 6. The imaging device may be configured by what is called an omnidirectional imaging device that can simultaneously take an image in all directions (360° in the horizontal direction, 360° in the vertical direction) having an imaging device main body at the center without exception. A plurality of ordinary imaging devices configured to take a planar image may be installed in the space 6 to take images of all the respective surfaces 61 with the plurality of imaging devices by allocation.

With these imaging devices, the images of the respective surfaces 61 of the space 6 planning to be additionally displayed are taken, and the vertical/horizontal size ratio between the respective surfaces 61 is determined using a well-known image analysis technique. The control unit 28 clips the image areas P to be assigned to the respective surfaces 61 similarly to the above based on the determined vertical/horizontal size ratio between the respective surfaces 61.

When the display device 7 is configured by a projection display device that projects and displays the image area P on the surface 61, the image area may be clipped by a method below.

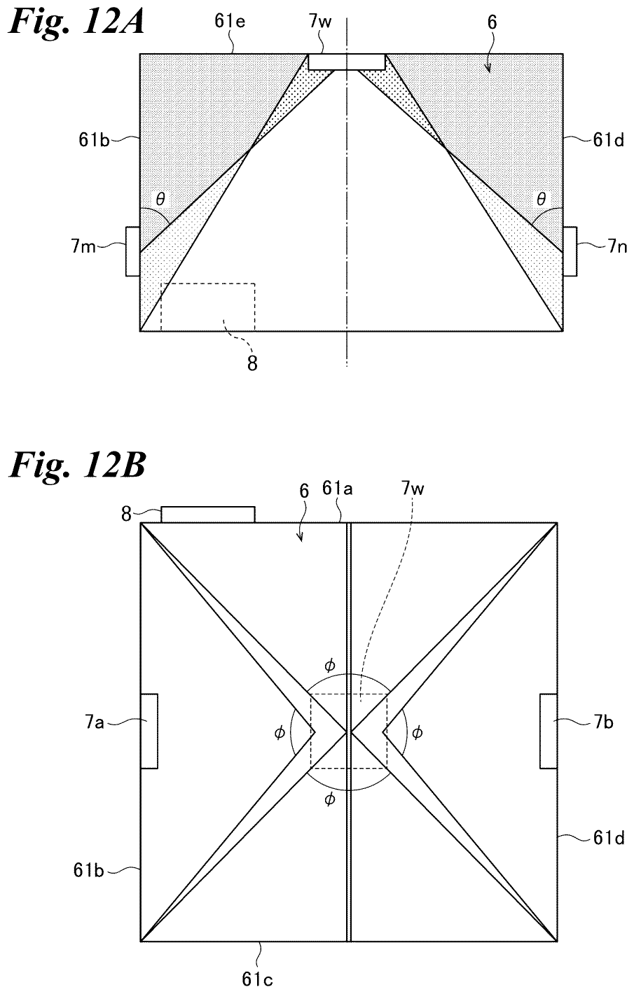

FIG. 12A is a cross-sectional side view of a certain space 6, and FIG. 12B is a plan view of it. On the surfaces 61b, 61d constituting side surfaces of the space 6, display devices 7m, 7w configured by projection display devices respectively and the audio device 8 are provided. Display devices 7m, 7n project and display the image areas P toward the surface 61e constituting a ceiling, and projection directions and view angles θ of the display devices 7 at this time are acquired. The display device 7w is provided on the surface 61e constituting the ceiling, and projects and displays the image areas P in four directions toward the surfaces 61a to 61d constituting the side surfaces in the four directions, and projection directions and view angles φ at this time are acquired. Further, information on a positional relation between the display devices 7m, 7n, 7w and the audio device 8 is acquired.

The acquisition of the projection directions, the view angles, and the positional relation may be performed by, for example, automatic determination by image taking with the imaging device installed in the space 6 as described above, in addition to the input through the operating unit 25.

Then, the image areas to be assigned to the respective surfaces may be clipped and the audio information reproduced by the audio device 8 may be assigned based on the acquired projection directions and view angles, or positional relation. While the audio device 8 is provided on the back surface of the surface 61a in FIGS. 12A and 12B, for example, the audio device 8 may be installed on a back surface of another surface or inside the space 6. Further, for example, the audio device 8 may be configured by combining a plurality of audio modules (audio components and the like) to constitute one audio device 8.

According to the present invention, the first dynamic image acquiring unit 21 and the second dynamic image acquiring unit 23 acquire the dynamic image including shooting information of the live video and the archived video, and the sound data acquiring unit 35 acquires the audio information corresponding to the dynamic image. The delivery destination information may be appropriately acquired based on, in addition to the shooting information, for example, management information, delivery request information, ranking information, past reproduction history information, spectator information, and the like of each moving image or the audio information, and the most appropriate delivery destination information may be acquired. For example, the delivery destination information may be preliminarily specified to the shooting information and acquired, and further, may be stored in the dynamic image storage unit 9.

According to the present invention, the first dynamic image acquiring unit 21 and the second dynamic image acquiring unit 23 acquire the dynamic image including shooting information of the live video and the archived video, and the sound data acquiring unit 35 acquires the audio information corresponding to the dynamic image. The delivery destination information may be appropriately acquired based on, in addition to the shooting information, for example, management information, delivery request information, ranking information, past reproduction history information, spectator information, and the like of each moving image or the audio information, and the most appropriate delivery destination information may be acquired. For example, the delivery destination information may be preliminarily specified to the shooting information and acquired, and further, may be stored in the dynamic image storage unit 9.

While the embodiments of the present invention have been described, the embodiments have been presented as examples, and are not intended to limit the scope of the invention. These novel embodiments can be embodied in a variety of other configurations. Various omissions, substitutions, and changes can be made without departing from the gist of the invention. The embodiments and the modifications thereof are within the scope and the gist of the invention and within the scope of the inventions described in the claims and their equivalents.

### DESCRIPTION OF REFERENCE SIGNS

1: Image area generation system
2: Control device
3: Recording module
5: Communications network
6: Space
7: Display device (reproduction device)
8: Audio device (reproduction device)
9: Dynamic image storage unit
21: First dynamic image acquiring unit
23: Second dynamic image acquiring unit
25: Operating unit
26: Space information acquiring unit
27: Determining unit
28: Control unit
31: Omnidirectional imaging device
32: Microphone
35: Sound data acquiring unit
61: Surface

1. An image area generation system that generates image areas displayed on respective rectangular surfaces surrounding a space, comprising:
dynamic image acquiring means that acquires a dynamic image;
image area clipping means that clips respective static images constituting the dynamic image acquired by the dynamic image acquiring means into a plurality of image areas corresponding to a positional relation between the respective surfaces;
assigning means that assigns the respective image areas clipped by the image area clipping means to the respective surfaces; and
data transmitting means that transmits data including the respective image areas assigned by the assigning means to respective display devices for displaying the image areas on the respective surfaces through mutually different channels, wherein
the data transmitting means performs an adjustment to mutually synchronize the respective image areas of the transmitted data on a time-series basis.

2. The image area generation system according to claim 1, further comprising
the display devices that display the image areas included in the data transmitted by the transmitting means on the respective surfaces.

3. The image area generation system according to claim 1, wherein
the dynamic image acquiring means acquires the dynamic image taken by an omnidirectional imaging device.

4. The image area generation system according to claim 1, wherein
the image area clipping means clips the image areas to be assigned to the respective surfaces based on a vertical/horizontal size ratio between the respective surfaces.

5. The image area generation system according to claim 4, wherein
the image area clipping means performs an adjustment such that each of the clipped image areas has a rectangular shape.

6. The image area generation system according to claim 1, further comprising
determining means that determines a vertical/horizontal size ratio between the respective surfaces based on images of the respective surfaces taken by an imaging device installed in the space, wherein
the image area clipping means clips the image areas to be assigned to the respective surfaces based on the vertical/horizontal size ratio between the respective surfaces determined by the determining means.

7. The image area generation system according to claim 1, wherein
the image area clipping means sequentially adds time-series identification information to each of the image areas clipped from the static images, and
the assigning means performs an adjustment for synchronization based on the time-series identification information added to each of the image areas.

8. The image area generation system according to claim 2, wherein
the display devices are configured by projection display devices that project and display the respective image areas on the respective surfaces, and
the image area clipping means clips the image areas to be assigned to the respective surfaces further based on a positional relation between the projection display devices or projection directions and view angles of the respective projection display devices with respect to the respective surfaces.

9. An image area display space that displays image areas on respective rectangular surfaces surrounding a space, comprising:
the respective rectangular surfaces surrounding the space;
dynamic image acquiring means that acquires a dynamic image;
image area clipping means that clips respective static images constituting the dynamic image acquired by the dynamic image acquiring means into a plurality of image areas corresponding to a positional relation between the respective surfaces;
assigning means that assigns the respective image areas clipped by the image area clipping means to the respective surfaces; and
data transmitting means that transmits data including the respective image areas assigned by the assigning means to respective display devices for displaying the image areas on the respective surfaces through mutually different channels, wherein
the data transmitting means performs an adjustment to mutually synchronize the respective image areas of the transmitted data on a time-series basis.

10. The image area display space according to claim 9, further comprising
determining means that determines a vertical/horizontal size ratio between the respective surfaces based on images of the respective surfaces taken by an imaging device installed in the space, wherein
the image area clipping means clips the image areas to be assigned to the respective surfaces based on the vertical/horizontal size ratio between the respective surfaces determined by the determining means.

11. An image area generation program for generating image areas displayed on respective rectangular surfaces surrounding a space, comprising:
a dynamic image acquiring step of acquiring a dynamic image;
an image area clipping step of clipping respective static images constituting the dynamic image acquired in the dynamic image acquiring step into a plurality of image areas corresponding to a positional relation between the respective surfaces;
an assigning step of assigning the respective image areas clipped in the image area clipping step to the respective surfaces; and
a data transmitting step of transmitting data including the respective image areas assigned in the assigning step to respective display devices for displaying the image areas on the respective surfaces through mutually different channels, wherein
the data transmitting step performs an adjustment to mutually synchronize the respective image areas of the transmitted data on a time-series basis.

12. An image area generation system that generates image areas reproduced on respective rectangular surfaces surrounding a space, comprising:
dynamic image acquiring means that acquires a dynamic image of at least any of a live video and an archived video, audio information corresponding to the dynamic image, and delivery destination information for delivering the dynamic image and the audio information;
image area clipping means that clips respective static images constituting the dynamic image into a plurality of image areas corresponding to a positional relation between the respective surfaces based on the delivery destination information acquired by the dynamic image acquiring means;
assigning means that determines features of the respective image areas clipped by the image area clipping means and a feature of the space and assigns the respective image areas to the respective surfaces based on the determined features of the respective image areas and feature of the space, as well as assigns the audio information based on the respective assigned image areas; and
data transmitting means that transmits data including at least any of the respective image areas or the audio information assigned by the assigning means to respective reproduction devices including at least any of respective display devices for reproducing the image areas on the respective surfaces or respective audio devices for reproducing the audio information through mutually different channels.

13. The image area generation system according to claim 12, wherein
the image area clipping means clips the respective static images constituting the dynamic image into the plurality of image areas corresponding to the positional relation between the respective surfaces based on the audio information.

14. The image area generation system according to claim 12, wherein
the data transmitting means performs an adjustment to mutually synchronize the respective image areas and the audio information of the transmitted data on a time-series basis.

15. An image area generation system that generates image areas reproduced on respective rectangular surfaces surrounding a space, comprising:
dynamic image acquiring means that acquires a dynamic image of at least any of a live video and an archived video, audio information corresponding to the dynamic image, and delivery destination information for delivering the dynamic image and the audio information;
image area clipping means that clips respective static images constituting the dynamic image into a plurality of image areas corresponding to a positional relation between the respective surfaces based on the delivery destination information acquired by the dynamic image acquiring means;
extracting means that extracts features of the respective image areas clipped by the image area clipping means and spectator information including any one or more of a position, a gaze, and a direction of a head of a spectator, and a voice emitted from the spectator in the space;
assigning means that assigns the respective image areas to the respective surfaces and assigns the audio information based on the respective assigned image areas; and
data transmitting means that transmits data including at least any of the respective image areas or the audio information assigned by the assigning means to respective reproduction devices including at least any of respective display devices for reproducing the image areas on the respective surfaces or respective audio devices for reproducing the audio information through mutually different channels, wherein
the dynamic image acquiring means resets a shooting condition of the live video based on the features of the respective image areas and the spectator information extracted by the extracting means.

16. An image area display space that reproduces image areas on respective rectangular surfaces surrounding a space, comprising:
the respective rectangular surfaces surrounding the space;
dynamic image acquiring means that acquires a dynamic image of at least any of a live video and an archived video, audio information corresponding to the dynamic image, and delivery destination information for delivering the dynamic image and the audio information;
image area clipping means that clips respective static images constituting the dynamic image into a plurality of image areas corresponding to a positional relation between the respective surfaces based on the delivery destination information acquired by the dynamic image acquiring means;
assigning means that determines features of the respective image areas clipped by the image area clipping means and a feature of the space and assigns the respective image areas to the respective surfaces based on the determined features of the respective image areas and feature of the space, as well as assigns the audio information based on the respective assigned image areas; and
data transmitting means that transmits data including at least any of the respective image areas or the audio information assigned by the assigning means to respective reproduction devices including at least any of respective display devices for reproducing the image areas on the respective surfaces or respective audio devices for reproducing the audio information through mutually different channels.

17. An image area generation program for generating image areas reproduced on respective rectangular surfaces surrounding a space, comprising:
a dynamic image acquiring step of acquiring a dynamic image of at least any of a live video and an archived video, audio information corresponding to the dynamic image, and delivery destination information for delivering the dynamic image and the audio information;
an image area clipping step of clipping respective static images constituting the dynamic image into a plurality of image areas corresponding to a positional relation between the respective surfaces based on the delivery destination information acquired in the dynamic image acquiring step;
an assigning step of determining features of the respective image areas clipped in the image area clipping step and a feature of the space and assigning the respective image areas to the respective surfaces based on the determined features of the respective image areas and feature of the space, as well as assigning the audio information based on the respective assigned image areas; and
a data transmitting step of transmitting data including at least any of the respective image areas or the audio information assigned in the assigning step to respective reproduction devices including at least any of respective display devices for reproducing the image areas on the respective surfaces or respective audio devices for reproducing the audio information through mutually different channels.
